(19) United States
(12) Patent Application Publication
(10) Pub. No.: US 2026/0277331 A1
(43) Pub. Date: Sep. 17, 2026

(54) SYSTEM FOR DMX-BASED WIRELESS CONTROL OF HAPTIC FEEDBACK IN WEARABLE DEVICES

(71) Applicant: CrowdSync Technology LLC, New York, NY (US)

(72) Inventors: Christopher Foote, New York, NY (US); Duncan Abdelnour, New York, NY (US); Lawrence Helfant, New York, NY (US); Brian Pelan, New York, NY (US)

(73) Assignee: CrowdSync Technology LLC, New York, NY (US)

(21) Appl. No.: 19/672,286

(22) Filed: May 8, 2026

Related U.S. Application Data
(63) Continuation-in-part of application No. 18/772,042, filed on Jul. 12, 2024.

(51) Int. Cl. G06F 3/01; H04W 4/80; H05B 47/18; H05B 47/19

(52) U.S. Cl. CPC G06F 3/016; H04W 4/80; H05B 47/184; H05B 47/19

(57) ABSTRACT

A system for controlling haptic feedback in wearable devices using Digital Multiplex (DMX)-based wireless communication is disclosed. The system includes a DMX control source configured to generate channel-based control signals corresponding to haptic parameters such as activation, intensity, timing, and pattern. The control signals are converted into wireless data and transmitted to one or more wearable devices. Each wearable device includes a receiver, a control unit, and a haptic actuator configured to generate tactile output based on the received signals. The system supports multiple levels of haptic intensity and enables real-time modulation of tactile feedback. In certain embodiments, wearable devices further include lighting elements synchronized with the haptic output. The system supports simultaneous and independent control of multiple wearable devices, including group-based or zone-based operation. Wireless communication may be implemented using radio frequency, Bluetooth, or other wireless protocols. The system enhances user engagement by enabling synchronized and programmable tactile experiences.

### CROSS-REFERENCE TO RELATED APPLICATIONS

This application is a continuation-in-part of U.S. Non-Provisional patent application Ser. No. 18/772,042, filed on Jul. 12, 2024, which claims the benefit of U.S. Provisional Patent Application Ser. No. 63/514,424, filed on Jul. 19, 2023, the entire contents of each of which are hereby incorporated herein by reference.

### STATEMENT REGARDING FEDERALLY SPONSORED RESEARCH OR DEVELOPMENT

Not Applicable.

### REFERENCE TO A SEQUENCE LISTING, A LARGE TABLE, OR A COMPUTER PROGRAM LISTING APPENDIX ON READ-ONLY OPTICAL DISC (IF APPLICABLE)

Not Applicable.

### FIELD OF THE INVENTION

This invention generally relates to systems and methods for controlling haptic feedback in wearable devices for enhanced audience engagement at live events, and more specifically, to a Digital Multiplex (DMX)-based wireless control architecture for triggering and modulating tactile and visual outputs across one or more wearable devices.

### BACKGROUND OF THE INVENTION

In recent times, the live event industry has increasingly adopted advanced technologies, including wearable devices, virtual reality, and live streaming, to enhance audience engagement and create immersive experiences. Various systems are designed to integrate audience members with event environments, such as auditoriums and large venues, to deliver synchronized visual and sensory effects. Among these, wearable devices have emerged as an effective medium for delivering interactive experiences to users.

Existing wearable-based solutions are often limited to localized functionality, such as onboard lighting or basic haptic feedback. While certain devices incorporate light-emitting elements and vibration mechanisms, the control of such features is typically restricted to predefined or device-specific operations. In particular, current systems lack a unified control architecture capable of dynamically coordinating haptic feedback across multiple devices in a synchronized and programmable manner. As a result, the ability to deliver complex, large-scale, and immersive tactile experiences remains limited.

Additionally, conventional systems frequently rely on manual activation or device-level triggering mechanisms, which restrict centralized control and coordinated interaction across multiple users. These approaches do not adequately support real-time modulation of haptic parameters such as intensity, timing, or pattern in response to live event conditions. Further, existing solutions lack scalable mechanisms for selectively addressing groups or zones of wearable devices, thereby limiting targeted audience engagement and coordinated event participation.

To address evolving requirements in live event environments, various wearable-based systems have been proposed. One such prior art reference discloses a wearable electronic accessory incorporating LED, Bluetooth, and RFID/NFC technologies for receiving information from connected devices and enabling identification and data exchange (U.S. Pub. No. US2017006414A1). The disclosed system enables functionalities such as identity accreditation, communication, and basic tactile alerts across a range of applications including events, healthcare, and sports. However, such systems are primarily limited to localized device-level functionality and do not provide flexible mechanisms for coordinated control of multiple wearable devices. In particular, existing solutions do not adequately support dynamic adjustment of haptic feedback parameters, nor do they enable scalable coordination of tactile outputs across multiple users within a live event environment. As a result, these systems are limited in their ability to deliver consistent and synchronized user experiences in large-scale deployments.

Although various audience engagement devices have been proposed, existing systems remain limited in their ability to provide coordinated control of both lighting effects and haptic effects across a plurality of devices in a live event environment. In many implementations, devices are configured to provide either isolated visual effects or isolated tactile effects, but not both in a synchronized and centrally managed manner. As a result, conventional systems do not adequately support creation of a unified multi-sensory experience for a large audience.

Further, conventional systems used in live events often lack a control framework capable of selectively addressing individual devices or groups of devices while simultaneously controlling multiple output parameters, such as color, intensity, timing, pattern, and vibration characteristics. This limitation restricts the ability of event producers, programmers, and operators to dynamically coordinate visual and tactile outputs in response to music, stage cues, show programming, audience participation, or other event conditions.

Existing audience engagement devices are also frequently tied to a particular physical implementation or product configuration, thereby limiting broader deployment of similar control functionality across multiple types of wearable or portable devices. However, live event applications may benefit from use of a common control architecture across a variety of different device types, including wrist-worn devices, badges, lanyards, clips, apparel-mounted devices, and other portable engagement units. Conventional systems do not adequately address this need for scalable and adaptable deployment across different form factors.

In addition, existing systems generally do not provide sufficient flexibility for programming complex or customizable control effects that integrate lighting outputs and haptic outputs within a common signaling environment. The inability to effectively coordinate such outputs across multiple devices reduces the overall immersive potential of audience engagement systems and limits the range of possible event experiences.

There is another invention disclosed in the prior art as a substrate with lighting effect (U.S. Pat. No. 9,474,137B1). This prior art describes a portable networked system configured to produce variable lighting effects within an event venue using multiple lighting devices. The system may include an active or passive RFID component for enabling identification or data-related functions associated with a user. In certain embodiments, the system may also provide vibration-based feedback. However, such systems are primarily directed toward lighting control and localized device functionality, and do not provide flexible mechanisms for coordinated control of multiple wearable devices. In particular, existing approaches do not adequately support dynamic and programmable adjustment of both visual and tactile outputs, nor do they enable scalable coordination of such outputs across multiple users within a live event environment. As a result, these systems are limited in their ability to deliver synchronized and interactive experiences at scale.

There is yet another invention disclosed in the prior art as a method of configuring lighting effect patterns for interactive lighting effect devices (U.S. Pat. No. 9,913,344 B2 ). This prior art describes a process for configuring and controlling lighting effect patterns for interactive lighting devices deployed within an event venue. The system utilizes RF-based data transmission to selectively activate lighting devices based on received data signals. However, such approaches are primarily directed toward lighting control and do not adequately address the integration of tactile feedback within wearable devices. In particular, existing systems do not provide flexible mechanisms for coordinated control of haptic outputs across multiple devices, nor do they support dynamic and scalable interaction among users in a live event environment. As a result, these systems are limited in their ability to deliver synchronized and immersive multi-sensory experiences.

Accordingly, there exists a need for an improved control system capable of enabling coordinated, scalable, and dynamic control of haptic feedback across multiple wearable devices in a live event environment.

### BRIEF SUMMARY OF THE INVENTION

The first aspect of the present invention provides a system for controlling haptic feedback in one or more wearable devices. The system includes a Digital Multiplex (DMX) control source configured to generate channel-based control signals, a wireless transmitter configured to convert the channel-based control signals into wireless data and transmit the wireless data. The system includes at least one wearable device comprising a receiver configured to receive the wireless data, a control unit operatively coupled to the receiver and configured to process the wireless data. A haptic actuator configured to generate a tactile output based on the processed wireless data.

In an embodiment, the channel-based control signals comprise one or more DMX channels corresponding to haptic control parameters including multiple levels of haptic intensity.

In another embodiment, the channel-based control signals correspond to one or more parameters including activation, intensity, timing, or pattern of the haptic actuator.

In yet another embodiment, the at least one wireless transmitter communicates via radio frequency (RF).

In yet another embodiment, the wireless transmitter is further configured to communicate via at least one of Bluetooth, 2.4 GHz wireless, 5 GHz wireless, or infrared.

In yet another embodiment, the at least one wearable device further comprises a plurality of lighting elements controlled via the DMX channels and configured to operate in synchronization with the haptic actuator.

In yet another embodiment, the system supports simultaneous and independent control of different types of wearable devices.

In yet another embodiment, the system supports group-based or zone-based control of the wearable devices.

In yet another embodiment, at least one wearable device comprises an RFID or NFC component configured to trigger the haptic actuator.

In yet another embodiment, the RFID or NFC triggering operates in combination with the DMX control signals.

In yet another embodiment, the haptic actuator comprises a haptic motor.

In yet another embodiment, the haptic motor comprises an eccentric rotating mass (ERM) motor or a linear resonant actuator (LRA).

The second aspect of the present invention provides a system for controlling haptic feedback in one or more wearable devices. The system includes a Digital Multiplex (DMX) control source configured to generate channel-based control signals comprising one or more DMX channels corresponding to haptic control parameters including multiple levels of haptic intensity, a wireless transmitter configured to convert the channel-based control signals into wireless data and transmit the wireless data via radio frequency (RF). The system comprises at least one wearable device comprising a receiver configured to receive the wireless data, a control unit operatively coupled to the receiver and configured to process the wireless data. The system includes a haptic actuator configured to generate a tactile output based on the processed wireless data. The system supports simultaneous and independent control of different types of wearable devices.

In an embodiment, the channel-based control signals correspond to one or more parameters including activation, intensity, timing, or pattern of the haptic actuator.

In another embodiment, the wireless transmitter is further configured to communicate via at least one of Bluetooth, 2.4 GHz wireless, 5 GHz wireless, or infrared.

In yet another embodiment, the at least one wearable device further comprises a plurality of lighting elements configured to operate in synchronization with the haptic actuator.

In yet another embodiment, the at least one wearable device comprises an RFID or NFC component configured to trigger the haptic actuator.

In yet another embodiment, the haptic actuator comprises a haptic motor that comprises an eccentric rotating mass (ERM) motor or a linear resonant actuator (LRA).

The third aspect of the present invention provides a system for controlling haptic feedback in one or more wearable devices. The system comprises a Digital Multiplex (DMX) control source configured to generate channel-based control signals comprising one or more DMX channels corresponding to haptic control parameters including activation, intensity, timing, or pattern of a haptic actuator, a wireless transmitter configured to convert the channel-based control signals into wireless data and transmit the wireless data via radio frequency (RF). The system includes at least one wearable device comprising a receiver configured to receive the wireless data, a control unit operatively coupled to the receiver and configured to process the wireless data, and a plurality of lighting elements configured to operate in synchronization with the haptic actuator. The haptic actuator comprises a haptic motor configured to generate vibration based on the processed wireless data. The haptic motor comprises an eccentric rotating mass (ERM) motor or a linear resonant actuator (LRA). The system supports simultaneous and independent control of different types of wearable devices and supports group-based or zone-based control.

In an embodiment, the wireless transmitter is further configured to communicate via at least one of Bluetooth, 2.4 GHz wireless, 5 GHz wireless, or infrared.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

FIG. 1 illustrates a system for providing haptic feedback to one or more wearable devices in a live event environment, according to various embodiments of the present invention.

FIG. 2 illustrates a workflow of DMX-based wireless control of haptic feedback in wearable devices, corresponding to the system of FIG. 1, according to various embodiments of the present invention.

FIG. 3 illustrates an implementation of the system of FIG. 1, wherein control signals from a lighting control source are wirelessly transmitted to a wearable device, such as a lanyard, to produce synchronized visual and haptic feedback, according to various embodiments of the present invention.

FIG. 4 illustrates a system associated with the system of FIG. 1, wherein a Digital Multiplex (DMX) control source transmits control signals to a plurality of wearable devices via a wireless transmitter according to various embodiments of the present invention.

FIG. 5 illustrates a method for controlling haptic feedback in one or more wearable devices according to various embodiments of the present invention.

Like reference numerals refer to like parts throughout the several views of the drawings.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion.

Nevertheless, the specification and claims should be read with the understanding that such combinations are entirely within the scope of the invention and the claims. System for DMX-based wireless control of haptic feedback in wearable devices is discussed herein. In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention and is not intended to limit the invention to the specific embodiments illustrated by the figures or description below. The present invention will now be described by referencing the appended figures representing preferred embodiments.

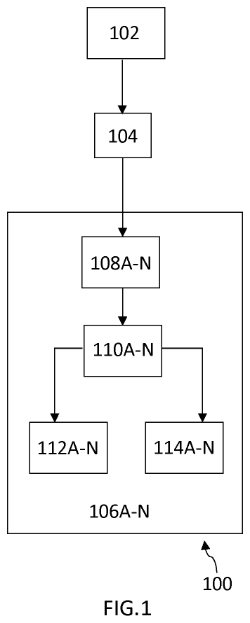

FIG. 1 illustrates a system for providing haptic feedback to one or more wearable devices in a live event environment, according to various embodiments of the present invention. The system 100 comprises a Digital Multiplex (DMX) control source 102, a wireless transmitter 104 operatively coupled to the DMX control source 102, and a plurality of wearable devices 106A-106N configured to receive control signals and generate haptic feedback. The DMX control source 102 may include a lighting console, software-based control system, or any DMX-compatible interface configured to generate channel-based digital control signals. Each DMX channel may correspond to a predefined parameter, including but not limited to activation or deactivation of haptic output, intensity levels of haptic feedback, temporal patterns or sequences, and synchronization triggers associated with event elements. In certain embodiments, one or more DMX channels are dedicated specifically to haptic control, enabling real-time adjustment of tactile output. The wireless transmitter 104 is configured to receive DMX control signals from the DMX control source 102, optionally via a DMX interface or decoder module, and to convert the signals into a wireless transmission format. The wireless transmitter 104 transmits corresponding control data to the wearable devices 106A-106N using one or more communication protocols. The communication protocols may include radio frequency (RF) transmission and, in alternative or complementary embodiments, may include Bluetooth, 2.4 GHz wireless, 5 GHz wireless, infrared (IR), or other wireless communication technologies, thereby enabling flexible deployment across different environments and system configurations.

Each wearable device 106A-106N comprises a receiver 108A-N configured to receive transmitted control signals, a control unit 110A-N operatively coupled to the receiver 108A-N, and a haptic actuator 112A-N configured to generate tactile feedback. The control unit 110A-N may include a microcontroller or processing circuitry configured to decode received control signals, map received data to predefined control parameters, and generate appropriate control signals for actuating the haptic actuator 112A-N. In certain embodiments, the control unit 110A-N may further include pulse width modulation (PWM) or equivalent control mechanisms to regulate haptic intensity and pattern generation.

The haptic actuator 112A-N is configured to generate a perceivable tactile output. In certain embodiments, the haptic actuator 112A-N comprises a haptic motor, including but not limited to an eccentric rotating mass (ERM) motor, or a linear resonant actuator (LRA). In alternative embodiments, the haptic actuator 112A-N may include piezoelectric actuators, electroactive polymers, or other electromechanical mechanisms capable of generating tactile sensations. The haptic actuator 112 is responsive to control signals derived from the DMX control source 102, enabling selective activation, deactivation, and modulation of vibration intensity and pattern. In certain embodiments, the wearable devices 106A-106N may further include one or more lighting elements 114A-N, such as light-emitting diodes (LEDs). The lighting elements 114A-N may be controlled via the same DMX-derived signals, enabling synchronized visual and haptic effects. The system 100 supports multi-level haptic intensity control, wherein intensity levels are mapped to one or more DMX channels. This enables dynamic, real-time adjustment of haptic feedback in response to live event conditions or programmed sequences. The system 100 further supports group-based or zone-based control, wherein the plurality of wearable devices 106A-106N are organized into one or more control groups. The wireless transmitter 104 selectively transmits control signals to specific groups, enabling targeted activation of haptic feedback in designated regions, and simultaneous or independent control of multiple groups. This facilitates coordinated audience interaction and localized effects within a live event.

The wearable devices 106A-106N may be implemented in any form factor, including but not limited to wristbands, badges, lanyards, clip-on devices, or other body-worn configurations. The invention is directed to the control architecture for haptic feedback, and is not limited by the physical structure of the wearable device 106A-106N. In operation, the DMX control source 102 generates control signals corresponding to desired haptic effects. These signals are transmitted via the wireless transmitter 104 to the one or more wearable devices 106A-106N. Upon receiving the signals, each wearable device 106A-106N processes the signals through the control unit 110A-N and actuates the haptic actuator 112A-N to generate tactile feedback. The generated haptic feedback may be synchronized with event elements such as audio signals, lighting effects, or predefined triggers, thereby enhancing user engagement. Additionally, the system 100 may be used to deliver targeted notifications or alerts, providing coordination or safety-related functionality within the event environment. Accordingly, the present invention is directed to a wireless, DMX-based control system for triggering haptic feedback in wearable devices, encompassing signal generation, transmission, reception, processing, and actuation, independent of wearable form factor.

In certain embodiments, the triggering of haptic feedback may be initiated via proximity-based communication, including Radio Frequency Identification (RFID) or Near Field Communication (NFC). In such embodiments, a reader device is configured to transmit a signal upon detecting a wearable device comprising an RFID or NFC-enabled component. Upon interaction with the reader device, such as a tap or proximity event, the wearable device receives a triggering signal which is processed by the control unit to activate a haptic actuator, including a haptic motor. The haptic response may correspond to a predefined vibration pattern, intensity level, or sequence stored within the wearable device or received dynamically from a control source. In certain embodiments, the RFID/NFC-triggered activation may operate independently or in conjunction with the DMX-based wireless control system, thereby enabling hybrid control modes. For example, RFID/NFC interaction may initiate or override a haptic event, while DMX-based signals control subsequent intensity, timing, or synchronization across multiple devices. The RFID/NFC-based triggering mechanism may be used to provide localized activation, user-specific interactions, or event-based cues, including entry validation, access control, targeted notifications, or coordinated activation of haptic feedback in response to user interaction. The system 100 is configured as a device-agnostic control architecture and is operable with a variety of wearable form factors without limitation to any specific physical configuration.

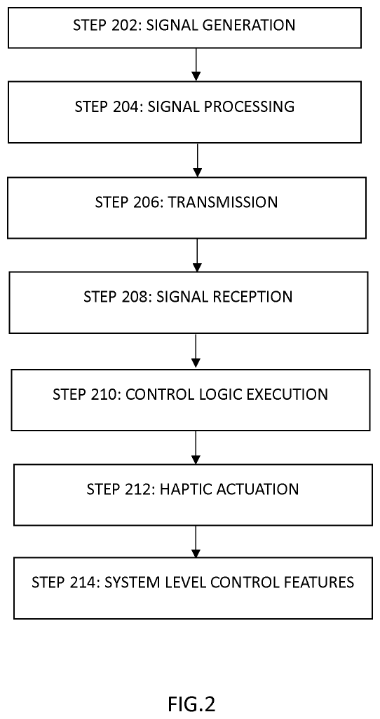

FIG. 2 illustrates a workflow of DMX-based wireless control of haptic feedback in wearable devices, corresponding to the system of FIG. 1, according to various embodiments of the present invention. At step 202, a DMX control source generates channel-based control signals corresponding to haptic parameters. The DMX control source may include a lighting console, software-based controller, or any DMX-compatible interface. In various embodiments, one or more DMX channels are assigned to activation or deactivation of haptic output, intensity levels of haptic feedback, temporal patterns or sequences, and synchronization triggers associated with event elements. At step 204, the DMX control signals are processed and interpreted, including decoding DMX data and mapping channel values to corresponding haptic control parameters. This processing may be performed at the transmitter side, receiver side, or distributed across both. At step 206, the processed control signals are transmitted via a wireless transmitter using one or more communication protocols. The communication protocols may include radio frequency (RF), Bluetooth, 2.4 GHz wireless, 5 GHz wireless, infrared (IR), or combinations thereof. In certain embodiments, the transmitter may support unicast, multicast, or broadcast transmission modes depending on system configuration. At step 208, one or more wearable devices receive the transmitted signals via a receiver module. The receiver decodes the incoming signals and forwards the decoded data to a control unit within the wearable device. At step 210, a control unit, such as a microcontroller, processes the received data and generates control instructions for actuating haptic feedback. In certain embodiments, the control unit utilizes pulse width modulation (PWM), driver circuitry, or equivalent control mechanisms to regulate intensity, duration, and pattern of haptic output. At step 212, a haptic actuator is actuated to generate a tactile response. In certain embodiments, the haptic actuator comprises a haptic motor, including an eccentric rotating mass (ERM) motor or a linear resonant actuator (LRA). In alternative embodiments, the haptic actuator may include piezoelectric elements, electroactive polymers, or other feedback-generating mechanisms capable of producing a perceivable tactile sensation. At step 214, the system enables group-based or zone-based control, wherein wearable devices are organized into one or more control groups. Control signals may be selectively transmitted to a single device, a subset of devices, or multiple groups simultaneously. In certain embodiments, the system supports synchronization with event triggers, including audio signals, lighting effects, or predefined event cues. In certain embodiments, the workflow further includes controlling lighting elements, such as LEDs, within the wearable device, thereby enabling synchronized visual and haptic effects. The workflow is independent of wearable form factor and may be implemented in devices including, but not limited to wristbands, badges, lanyards, clip-on devices, or other body-wearable configurations. Accordingly, the workflow defines a complete control pipeline encompassing signal generation, processing, transmission, reception, control logic execution, and actuation, enabling programmable and synchronized haptic feedback across one or more wearable devices in a live event environment.

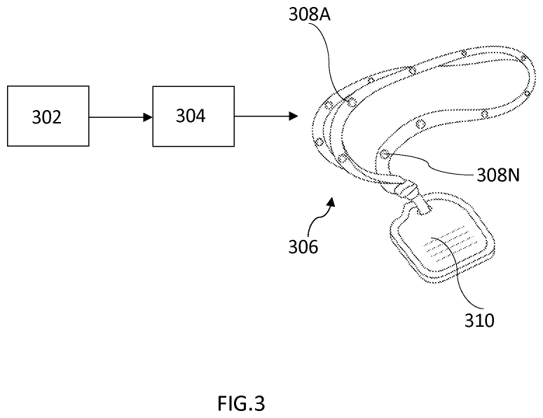

FIG. 3 illustrates an implementation of the system of FIG. 1, wherein control signals from a lighting control source are wirelessly transmitted to a wearable device, such as a lanyard, to produce synchronized visual and haptic feedback, according to various embodiments of the present invention. A lighting console 302 is configured to generate Digital Multiplex (DMX)-based control signals. The lighting console 302 may include a hardware lighting controller, software-based interface, or any DMX-compatible control system capable of generating channel-based data corresponding to lighting and haptic parameters. The DMX control signals are provided to a wireless transmitter 304, which converts the DMX signals into wireless data packets. The wireless transmitter 304 transmits the data packets via one or more wireless communication protocols, including radio frequency (RF), Bluetooth, 2.4 GHz wireless, 5 GHz wireless, infrared (IR), or combinations thereof. The wireless data packets are received by a lanyard device 306, comprising the receiver configured to receive and decode the transmitted data packets. The receiver communicates the decoded signals to a control unit within the lanyard device 306. The control unit processes the received signals and generates control instructions for one or more output components of the lanyard device 306. The lanyard device 306 comprises lighting elements 308A-N, such as LEDs, and a haptic actuator including a vibration device 310. Based on the received control signals, the control unit selectively actuates the lighting elements 308A-N to produce visual output and the haptic actuator to generate tactile feedback. The control signals define one or more parameters including color, intensity, timing, pattern, and synchronization of lighting and haptic outputs. In certain embodiments, the system enables synchronized operation across a plurality of wearable devices, including lanyard devices 306, to produce coordinated visual and tactile effects during a live event. The system further supports selective control of subsets of wearable devices organized into one or more groups or zones, wherein control signals are transmitted to target specific groups or multiple groups simultaneously.

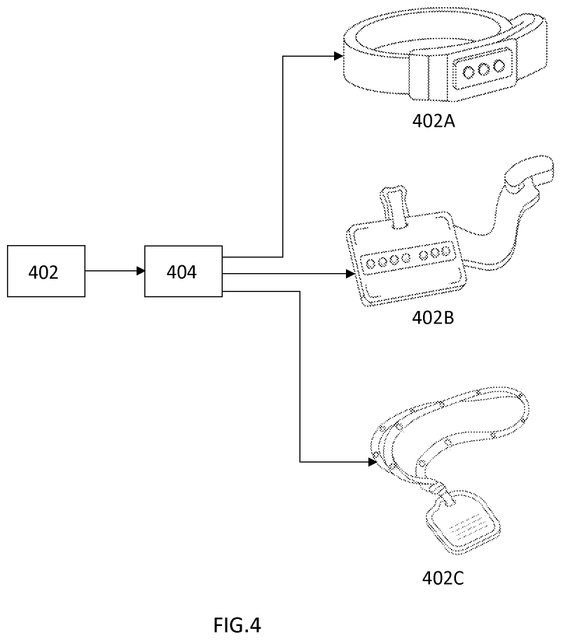

FIG. 4 illustrates a system associated with the system of FIG. 1, wherein a Digital Multiplex (DMX) control source transmits control signals to a plurality of wearable devices via a wireless transmitter according to various embodiments of the present invention. The DMX control source 402 generates channel-based control signals corresponding to one or more parameters, including lighting and haptic control parameters such as activation, intensity, timing, and pattern. The control signals are communicated to a wireless transmitter 404, which converts the DMX signals into wireless data packets and transmits the data packets via one or more communication protocols, including radio frequency (RF), Bluetooth, 2.4 GHz wireless, 5 GHz wireless, infrared (IR), or combinations thereof. The transmitted signals are received by a plurality of wearable devices 406A-406C, illustrated as including a wearable watch device 406A, a badge device 406B, and a lanyard device 406C. Each wearable device comprises a receiver, a control unit, and one or more output components. In certain embodiments, the wearable devices include lighting elements, such as LEDs, and haptic actuators, including haptic motors, configured to generate visual and tactile outputs based on the received control signals. The system enables simultaneous or coordinated control of multiple wearable devices of different form factors using a single DMX control source. The control signals may be configured to produce synchronized visual and haptic effects across all devices or selectively across specific devices. In certain embodiments, the system supports group-based or zone-based control, wherein subsets of wearable devices, such as only badge devices or only lanyard devices, are selectively controlled independently or in combination. The illustrated wearable devices are exemplary, and the system may be implemented with any wearable form factor, including but not limited to wristbands, watches, badges, lanyards, clip-on devices, or other body-worn configurations, without departing from the scope of the invention.

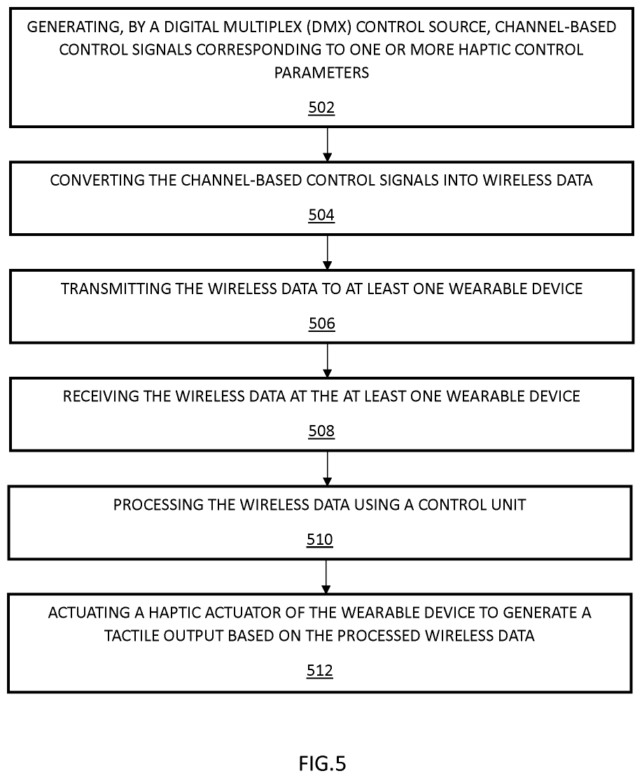

FIG. 5 illustrates a method for controlling haptic feedback in one or more wearable devices according to various embodiments of the present invention. At step 502, the method includes generating, by a Digital Multiplex (DMX) control source, channel-based control signals corresponding to one or more haptic control parameters. The channel-based control signals comprise one or more DMX channels corresponding to multiple levels of haptic intensity. At step 504, the method includes converting the channel-based control signals into wireless data. At step 506, the method includes transmitting the wireless data to at least one wearable device. The wireless data is transmitted via radio frequency (RF), Bluetooth, 2.4 GHz wireless, 5 GHz wireless, or infrared communication. At step 508, the method includes receiving the wireless data at the at least one wearable device. At step 510, the method includes processing the wireless data using a control unit. At step 512, the method includes actuating a haptic actuator of the wearable device to generate a tactile output based on the processed wireless data. The method may comprise controlling one or more lighting elements of the wearable device in synchronization with the haptic actuator. The method may comprise controlling a plurality of wearable devices simultaneously or selectively in one or more groups or zones. The method may comprise triggering the haptic actuator using an RFID or NFC signal in combination with the channel-based control signals.

While the present invention has been described in terms of particular embodiments and applications, in both summarized and detailed forms, it is not intended that these descriptions in any way limit its scope to any such embodiments and applications. It will be understood that many substitutions, changes and variations in the described embodiments, applications and details of the method and system illustrated herein and of their operation can be made by those skilled in the art without departing from the spirit of this invention.

What is claimed is:

1. A system for controlling haptic feedback in one or more wearable devices, the system comprising:
a Digital Multiplex (DMX) control source configured to generate channel-based control signals;
a wireless transmitter configured to convert the channel-based control signals into wireless data and transmit the wireless data; and
at least one wearable device comprising:
a receiver configured to receive the wireless data;
a control unit operatively coupled to the receiver and configured to process the wireless data; and
a haptic actuator configured to generate a tactile output based on the processed wireless data.

2. The system of claim 1, wherein the channel-based control signals comprise one or more DMX channels corresponding to haptic control parameters including multiple levels of haptic intensity.

3. The system of claim 2, wherein the channel-based control signals correspond to one or more parameters including activation, intensity, timing, or pattern of the haptic actuator.

4. The system of claim 1, wherein the wireless transmitter communicates via radio frequency (RF).

5. The system of claim 4, wherein the wireless transmitter is further configured to communicate via at least one of Bluetooth, 2.4 GHz wireless, 5 GHz wireless, or infrared.

6. The system of claim 1, wherein the wearable device further comprises a plurality of lighting elements controlled via the DMX channels and configured to operate in synchronization with the haptic actuator.

7. The system of claim 1, wherein the system supports simultaneous and independent control of different types of wearable devices.

8. The system of claim 1, wherein the system supports group-based or zone-based control of the wearable devices.

9. The system of claim 1, wherein at least one wearable device comprises an RFID or NFC component configured to trigger the haptic actuator.

10. The system of claim 9, wherein the RFID or NFC triggering operates in combination with the DMX control signals.

11. The system of claim 1, wherein the haptic actuator comprises a haptic motor.

12. The system of claim 11, wherein the haptic motor comprises an eccentric rotating mass (ERM) motor or a linear resonant actuator (LRA).

13. A system for controlling haptic feedback in one or more wearable devices, the system comprising:
a Digital Multiplex (DMX) control source configured to generate channel-based control signals comprising one or more DMX channels corresponding to haptic control parameters including multiple levels of haptic intensity;
a wireless transmitter configured to convert the channel-based control signals into wireless data and transmit the wireless data via radio frequency (RF); and
at least one wearable device comprising:
a receiver configured to receive the wireless data;
a control unit operatively coupled to the receiver and configured to process the wireless data; and
a haptic actuator configured to generate a tactile output based on the processed wireless data,
wherein the system supports simultaneous and independent control of different types of wearable devices.

14. The system of claim 13, wherein the channel-based control signals correspond to one or more parameters including activation, intensity, timing, or pattern of the haptic actuator.

15. The system of claim 13, wherein the wireless transmitter is further configured to communicate via at least one of Bluetooth, 2.4 GHz wireless, 5 GHz wireless, or infrared.

16. The system of claim 13, wherein the wearable device further comprises a plurality of lighting elements configured to operate in synchronization with the haptic actuator.

17. The system of claim 13, wherein at least one wearable device comprises an RFID or NFC component configured to trigger the haptic actuator.

18. The system of claim 13, wherein the haptic actuator comprises a haptic motor that comprises an eccentric rotating mass (ERM) motor or a linear resonant actuator (LRA).

19. A system for controlling haptic feedback in one or more wearable devices, the system comprising:
a Digital Multiplex (DMX) control source configured to generate channel-based control signals comprising one or more DMX channels corresponding to haptic control parameters including activation, intensity, timing, or pattern of a haptic actuator;
a wireless transmitter configured to convert the channel-based control signals into wireless data and transmit the wireless data via radio frequency (RF); and
at least one wearable device comprising:
a receiver configured to receive the wireless data;
a control unit operatively coupled to the receiver and configured to process the wireless data; and
a plurality of lighting elements configured to operate in synchronization with the haptic actuator,
the haptic actuator comprising a haptic motor configured to generate vibration based on the processed wireless data, wherein the haptic motor comprises an eccentric rotating mass (ERM) motor or a linear resonant actuator (LRA),
wherein the system supports simultaneous and independent control of different types of wearable devices and supports group-based or zone-based control.

20. The system of claim 19, wherein the wireless transmitter is further configured to communicate via at least one of Bluetooth, 2.4 GHz wireless, 5 GHz wireless, or infrared.
